(19) United States
(12) Patent Application Publication
(10) Pub. No.: US 2015/0036381 A1
(43) Pub. Date: Feb. 5, 2015

(54) BACKLIGHT MODULE AND LIQUID CRYSTAL DISPLAY INCLUDING THE SAME

(71) Applicant: SHENZHEN CHINA STAR OPTOELECTRONICS TECHNOLOGY CO., LTD., Shenzhen, Guangdong (CN)

(72) Inventor: Gege Zhou, Shenzhen (CN)

(73) Assignee: SHENZHEN CHINA STAR OPTOELECTRONICS TECHNOLOGY CO., LTD., Shenzhen, Guangdong (CN)

(21) Appl. No.: 14/241,406

(22) PCT Filed: Jan. 24, 2014
(86) PCT No.: PCT/CN2014/071387

§ 371 Date: Feb. 26, 2014

(30) Foreign Application Priority Data
Jul. 18, 2013 (CN) 201310303478.7

(51) Int. Cl. F21V 8/00; G02F 1/1335

(52) U.S. Cl. CPC G02B 6/0085; G02F 1/1336; G02F 2001/133628
USPC 362/611

(57) ABSTRACT

The present disclosure relates to a backlight module and a liquid crystal display comprising the backlight module. The backlight module comprises a light guide plate, a glue frame, and a bent heat dissipating plate for fixing the glue frame. A light source lamp facing the light guide plate is arranged on the side wall of the heat dissipating plate at the light-incoming side of the light guide plate. At least one mounting block projecting away from the light guide plate is arranged on the side wall of the heat dissipating plate at the light-incoming side of the light guide plate, and can be engaged with the glue frame for fixing the glue frame. According to the backlight module of the present disclosure, the frame of the liquid crystal display can be significantly narrowed without leading to other problems in the liquid crystal display.

### FIELD OF THE INVENTION

The present disclosure relates to a liquid crystal device, in particular to a backlight module and a liquid crystal display including the backlight module.

### BACKGROUND OF THE INVENTION

Thin film transistor liquid crystal display (namely TFT-LCD) is one of the major types of flat panel displays at present, and is widely used in electronic equipment. A backlight module of TFT-LCD mainly comprises s a back plate, a light guide plate, a light bar, a heat dissipating plate, an optical diaphragm, a glue frame, a front frame, and the like.

Currently, the frame of a liquid crystal display tends to be narrower and narrower, which requires that of the backlight module to be narrower. Thus, in order to narrow the frame, the back plate can be removed. However, in this case the mechanical strength of the whole backlight module might be greatly weakened, which would easily lead to other problems. Another option is to narrow the glue frame, which, however, can only narrow the frame of the liquid crystal display to a lesser extent. In addition, a narrower frame can be realized by providing a thinner side wall of the heat dissipating plate, but this would negatively influence the heat dissipating effect of the liquid crystal display. Therefore, a method of greatly narrowing the frame without leading to other problems to the liquid crystal display is needed.

### SUMMARY OF THE INVENTION

To solve the above technical problems in the prior art, the present disclosure proposes a backlight module which can greatly narrow the frame of a liquid crystal display without leading to other problems to the liquid crystal display. The present disclosure further relates to a liquid crystal display using the backlight module.

1) According to the first aspect of the present disclosure, a backlight module is provided, comprising a light guide plate, a glue frame, and a bent heat dissipating plate for fixing the glue frame, wherein a light source lamp facing the light guide plate is arranged on the side wall of the heat dissipating plate at the light-incoming side of the light guide plate, and at least one mounting block projecting away from the light guide plate is arranged on the side wall of the heat dissipating plate at the light-incoming side of the light guide plate, and can be engaged with the glue frame for fixing the glue frame.

According to the backlight module of the present disclosure, the light source lamp is directly arranged on the heat dissipating plate, thus rendering components for mounting the light source lamp unnecessary. In this manner, the frame of the liquid crystal display can be significantly narrowed, and the heat dissipating performance of the backlight module can be significantly increased. In addition, the heat dissipating plate can also be used for fixedly locating the glue frame, thus facilitating assembly for the backlight module.

2) In an embodiment of 1) of the present disclosure, an inserting port is formed on the glue frame, and the mounting block can insert into the inserting port for secure connection of the heat dissipating plate and the glue frame. Due to the engagement between the mounting block and the glue frame, the main body structure of the heat dissipating plate does not need to be changed, so that circuits on the heat dissipating plate do not need to be redesigned and rearranged, and therefore will not be damaged. Therefore, the production of the heat dissipating plate can be facilitated. In a preferred example, a plurality of mounting blocks arranged at intervals is provided.

3) In an embodiment of 1) or 2) of the present disclosure, bent blocks projecting towards the light guide plate and each having a thickness larger than the light source lamp are arranged on the side wall of the heat dissipating plate provided with the mounting block, and can be abutted against the light guide plate to protect the light source lamp. The light source lamp can be arranged in a region between the bent blocks. With this structure, a certain gap exists between the light guide plate and the light source lamp, thus preventing the light guide plate from colliding with the light source lamp. In addition, the light guide plate may be also placed directly adjacent to the bent blocks, thus ensuring the coupled light distance. In a preferred example, two bent blocks arranged at an interval are provided, and the mounting block is placed in a region between the two bent blocks.

4) In an embodiment of any one of 1) to 3) of the present disclosure, when being assembled, the base plate of the heat dissipating plate is located below the light guide plate. Projections in contact with the light guide plate are arranged on the base plate of the heat dissipating plate. With this structure, the good heat dissipating performance of the backlight module can be ensured, and the mechanical strength of the backlight module can also be improved.

5) According to the second aspect of the present disclosure, a liquid crystal display with the above-mentioned backlight module is provided. In a specific embodiment, the liquid crystal display further includes a panel and an outer frame for assembling a backlight module and the panel together.

In this application, the term “the inner side of the side wall of the heat dissipating plate” indicates that the side wall of the heat dissipating plate faces the lateral surface of the light guide plate, and the term “below the light guide plate” indicates a direction away from the light guide plate and the external environment.

Compared with the prior art, the present disclosure has the advantages that the light source lamp is directly arranged on the heat dissipating plate, thus rendering components for mounting the light source lamp unnecessary. In this manner, the frame of the liquid crystal display can be significantly narrowed. With the mounting block being arranged on the side wall of the heat dissipating plate and an inserting connection with the glue frame being realized by virtue of the mounting block, the main body structure of the heat dissipating plate does not need to be changed, so that circuits on the heat dissipating plate do not need to be redesigned and rearranged, and therefore will not be damaged. Therefore, the production of the heat dissipating plate can be facilitated. In addition, the bent blocks projecting towards the light guide plate and each having a thickness larger than the light source lamp are arranged on the side wall of the heat dissipating plate. Therefore, the bent blocks can abut against the light guide plate so that a certain gap exists between the light guide plate and the light source lamp, thus preventing the light guide plate from colliding with the light source lamp. Moreover, the light guide plate may be also placed directly adjacent to the bent blocks, thus ensuring the coupled light distance.

### BRIEF DESCRIPTION OF THE DRAWINGS

The present disclosure will be described in more detail below based on the embodiments with reference to the accompanying drawings, in which:

FIG. 1 is a three-dimensional schematic diagram of a liquid crystal display according to the present disclosure;

FIG. 2 is a three-dimensional schematic diagram of a heat dissipating plate according to the present disclosure;

FIG. 3 shows the heat dissipating plate of FIG. 2 viewed from direction A in FIG. 2;

FIG. 4 shows a first cross-section diagram of a backlight module according to the present disclosure; and

FIG. 5 shows a second cross-section diagram of a backlight module according to the present disclosure.

In the accompanying drawings, the same components are indicated by the same reference signs. The accompanying drawings are not drawn in an actual scale.

### DETAILED DESCRIPTION OF THE EMBODIMENTS

The present disclosure will be further illustrated below in conjunction with the accompanying drawings.

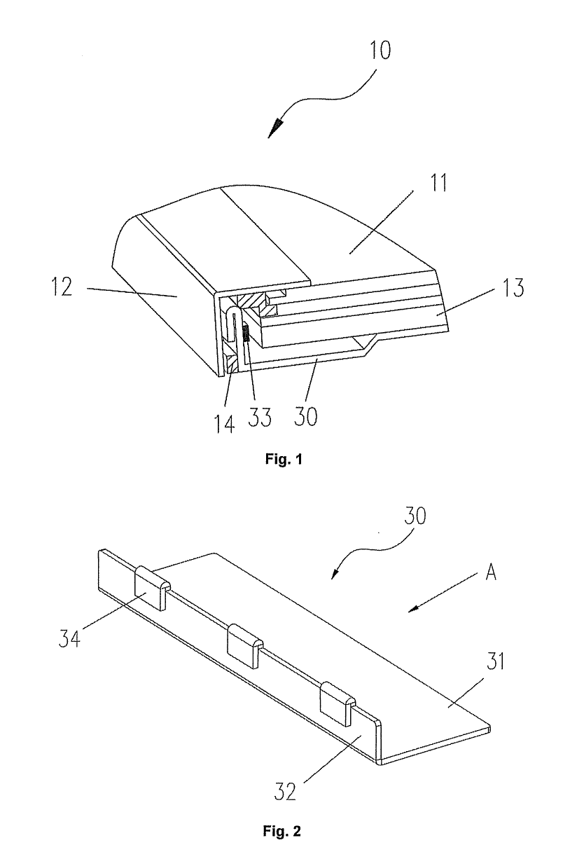

FIG. 1 schematically shows a part of a liquid crystal display 10 according to the present disclosure in the form of a three-dimensional view. The liquid crystal display 10 mainly includes a panel 11, a backlight module, and an outer frame 12 for assembling the panel 11 and the backlight module together. It shall be understood that the liquid crystal display 10 further comprises other components, which, along with their assembly structures, are known to those skilled in the art. For the sake of conciseness, they will not be described here.

As shown in FIG. 1, the backlight module comprises a light guide plate 13, a glue frame 14 and a heat dissipating plate 30, wherein the heat dissipating plate 30 is structured to be bent, namely provided with a base plate 31 and a side wall 32 substantially perpendicular to the base plate 31 (as shown in FIG. 2). When being assembled, the base plate 31 is located below the light guide plate 13, and the side wall 32 is located at the light-incoming side of the light guide plate 13. A light source lamp 33 is arranged on the side wall 32 of the heat dissipating plate 30, so that light can be emitted to the light guide plate 13 to illuminate a liquid crystal screen. The light source lamp 33 being directly arranged on the heat dissipating plate 30 not only improves the heat dissipating performance of the backlight module, but also saves components (not shown) for mounting the light source lamp 33. In this case, the objective of greatly narrowing the frame of the liquid crystal display 10 can be achieved.

As shown in FIG. 4 and FIG. 5, projections 36 are arranged on the base plate 31 of the heat dissipating plate 30. When being assembled, the projections 36 will contact with the light guide plate 13, thereby improving the heat dissipating performance of the backlight module. Moreover, the heat dissipating plate 30 with such a structure can also support the light guide plate 13, thereby improving the mechanical property of the backlight module.

FIG. 2 schematically shows the heat dissipating plate 30 according to the present disclosure in the form of a three-dimensional view. It should be noted that FIG. 2 merely shows a part of the heat dissipating plate 30, and therefore the projections 36 on the heat dissipating plate 30 are not shown. In order to fix the glue frame 14, at least one mounting block 34 projecting away from the light guide plate 13 is arranged on the side wall 32 of the heat dissipating plate 30, and an inserting port 15 (as shown in FIG. 4) matched with the mounting block 34 is formed on the glue frame 14. When being assembled, the mounting block 34 will insert into the inserting port 15, so as to position the glue frame 14 in a reliable manner. In an example, the mounting block 34 is arranged on an upper part of the side wall 32, namely, a part of the side wall 32 away from the base plate 31. In another example, a plurality of mounting blocks 34 are provided, and uniformly arranged at intervals along the length direction of the side wall 32.

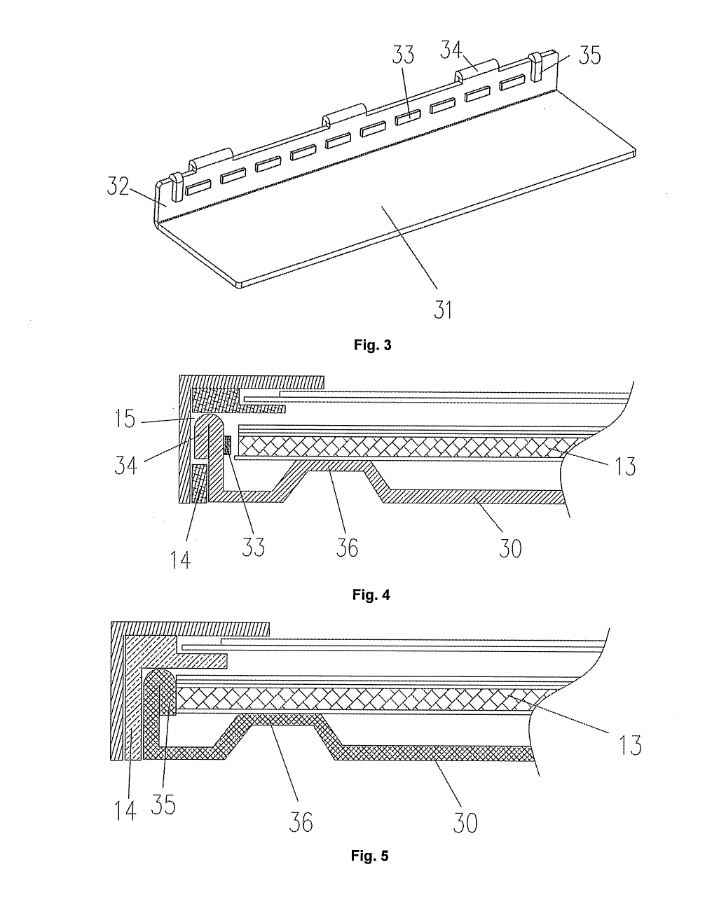

FIG. 3 shows the heat dissipating plate of FIG. 2 viewed from direction A in FIG. 2. Similarly, it should be noted that FIG. 3 also merely shows a part of the heat dissipating plate 30, and therefore the projections 36 on the heat dissipating plate 30 are not shown. As shown in FIG. 3, at lease one light source lamp 33 facing the light guide plate 13 is arranged on the side wall 32 of the heat dissipating plate 30 at the light-incoming side of the light guide plate 13. That is, the light source lamp 33 is arranged at the inner side (i.e., the side surface facing the light guide plate 13) of the side wall 32. In an example, the light source lamp 33 is selected as a light emitting diode (LED) module. In order to protect the light source lamp 33 from being damaged by the light guide plate 13, bent blocks 35 each having a thickness larger than the light source lamp 33 are arranged on the side wall 32. When being assembled, the bent blocks 35 can be abutted against the light-incoming side of the light guide plate 13, as shown in FIG. 5. In this case, the light guide plate 13 cannot contact the light source lamp 33, and then cannot collide with the light source lamp 33. In addition, the light guide plate 13 may be also placed directly adjacent to the bent blocks 35, thus ensuring the coupled light distance. In an example, two bent blocks 35 are provided, and the light source lamp 33 is arranged in a region between the two bent blocks 35. In this case, a light emitted by the light source lamp 33 cannot be shielded by the bent blocks 35, thus increasing the brightness of the backlight module.

Although the present disclosure has been described with reference to the preferred examples, various modifications could be made to the present disclosure without departing from the scope of the present disclosure and components in the present disclosure could be substituted by equivalents. Particularly, as long as structural conflicts do not exist, all technical features mentioned in all the embodiments may be combined together in any manner. The present disclosure is not limited to the specific examples disclosed in the description, but includes all technical solutions falling into the scope of the claims.

1. A backlight module, comprising a light guide plate, a glue frame, and a bent heat dissipating plate for fixing the glue frame, a light source lamp facing the light guide plate being arranged on the side wall of the heat dissipating plate at the light-incoming side of the light guide plate, wherein at least one mounting block projecting away from the light guide plate is arranged on the side wall of the heat dissipating plate at the light-incoming side of the light guide plate, and can be engaged with the glue frame for fixing the glue frame.

2. The backlight module according to claim 1, wherein an inserting port is formed on the glue frame, and the mounting block inserts into the inserting port for secure connection of the heat dissipating plate and the glue frame.

3. The backlight module according to claim 2, wherein a plurality of mounting blocks arranged at intervals is provided.

4. The backlight module according to claim 2, wherein bent blocks projecting towards the light guide plate and each having a thickness larger than the light source lamp are arranged on the side wall of the heat dissipating plate provided with the mounting block, and can be abutted against the light guide plate to protect the light source lamp.

5. The backlight module according to claim 4, wherein two bent blocks arranged at an interval are provided, and the mounting block is placed in a region between the two bent blocks.

6. The backlight module according to claim 5, wherein when being assembled, the base plate of the heat dissipating plate is located below the light guide plate.

7. The backlight module according to claim 6, wherein projections in contact with the light guide plate are arranged on a base plate of the heat dissipating plate.

8. The backlight module according to claim 7, wherein the light source lamp is placed in a region between the bent blocks.

9. A liquid crystal display comprising a backlight module, which comprises a light guide plate, a glue frame, and a bent heat dissipating plate for fixing the glue frame, a light source lamp facing the light guide plate being arranged on the side wall of the heat dissipating plate at the light-incoming side of the light guide plate, wherein at least one mounting block projecting away from the light guide plate is arranged on the side wall of the heat dissipating plate at the light-incoming side of the light guide plate, and can be engaged with the glue frame for fixing the glue frame.
